(19) United States
(12) Patent Application Publication
(10) Pub. No.: US 2003/0147007 A1
(43) Pub. Date: Aug. 7, 2003

(54) Combined television receiver/video cassette recorder, video cassette recorder, audio/control head for combined television receiver/video cassette recorder, and audio/control head for video cassette recorder

(76) Inventor: Masaki Itoh, Osaka (JP)

Correspondence Address: ROSENTHAL & OSHA L.L.P., 1221 MCKINNEY AVENUE, SUITE 2800, HOUSTON, TX, 77010, US

(21) Appl. No.: 10/345,507

(22) Filed: Jan. 16, 2003

(30) Foreign Application Priority Data
Feb. 6, 2002 (JP) 2002-492(U)
May 15, 2002 (JP) 2002-140546(P)

(51) Int. Cl. H04N 5/64; H04N 11/00; H04N 5/76

(52) U.S. Cl. 348/552; 348/836; 386/46

(57) ABSTRACT

In a combined television receiver/video cassette recorder including an upper television receiver portion and a lower video cassette recorder portion, a boundary magnetic shield sheet of silicon steel conventionally used between the television receiver portion and the video cassette recorder portion is dispensed with, and an audio magnetic shield sheet of silicon steel that is smaller than the boundary magnetic shield sheet is provided on a cap of an audio/control head included in the video cassette recorder portion.

### BACKGROUND OF THE INVENTION

1. Field of the Invention

The present invention relates to a video tape recording/reproducing device, and more particularly to technique that can reduce magnetic noise entering into an audio/control head (hereinafter also referred to as “A/C head”) at low costs. In the present application, the term “video cassette recorder” means a video tape recording/reproducing device, e.g., a device capable of recording and reproducing information on a tape or a device capable of reproducing information on a tape. Recently, a video cassette recorder is not only combined with a television receiver, but also is incorporated in a composite product including a DVD (digital video disk) player and/or the like.

2. Description of the Background Art

FIG. 1 is a schematic perspective view showing a conventional combined television receiver/video cassette recorder (hereinafter also referred to as “combined TV/VCR”) 100 including an upper television receiver portion 101 and a lower video cassette recorder portion 102. When video cassette recorder portion 102 is integrated with television receiver portion 101 as in combined TV/VCR 100, a boundary magnetic shield sheet 103 is provided at a boundary portion between television receiver portion 101 and video cassette recorder portion 102 in order to prevent an adverse effect on video cassette recorder portion 102 caused by magnetic noise from television receiver portion 101. Boundary magnetic shield sheet 103 is usually formed by a silicon steel sheet having a relatively large area of 10 cm×10 cm.

Such incorporation of large boundary magnetic shield sheet 103 made of silicon steel into combined TV/VCR 100 requires a significant workload while increasing the costs of the combined TV/VCR.

### SUMMARY OF THE INVENTION

In view of such circumstances in the conventional art as described above, an object of the present invention is to provide a combined TV/VCR that eliminates the need for a large, hard-to-handle and costly boundary magnetic shield sheet. Another object of the present invention is to provide a video cassette recorder that can prevent an adverse effect of magnetic noise from a television receiver, a DVD player or the like, even if the television receiver or the like is put thereon. A further object of the present invention is to provide a generally usable A/C head giving indemnity for influence of magnetic noise in the case of being used in a combined TV/VCR or a video cassette recorder.

According to one aspect of the present invention, in a combined television receiver/video cassette recorder including an upper television receiver portion and a lower video cassette recorder portion, a boundary magnetic shield sheet of silicon steel conventionally used between the television receiver portion and the video cassette recorder portion is dispensed with, and an audio magnetic shield sheet of silicon steel smaller than the boundary magnetic shield sheet is provided on a cap of an audio/control head included in the video cassette recorder portion.

According to another aspect of the present invention, in a video cassette recorder case, at least a top plate of which is made of synthetic resin, an audio magnetic shield sheet of silicon steel is provided on a cap of an audio/control head included in a recording/reproducing portion.

It is noted that, in any aspect of the present invention, the audio magnetic shield sheet desirably has an area of at least eleven times an area of the cap. Further, it is preferable that the cap is also formed of a silicon steel sheet.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic perspective view showing a conventional combined television receiver/video cassette recorder;

FIG. 2 is a schematic perspective view showing a conventional video cassette recorder;

FIG. 3 is a schematic plan view showing a recording/reproducing portion included in a video cassette recorder portion;

FIG. 4 is a schematic perspective view of an audio/control head included in the recording/reproducing portion of FIG. 3;

FIG. 5A is an oscillograph showing amplitude of noise included in a reproduction signal of the A/C head in the combined TV/VCR of FIG. 1;

FIG. 5B is an oscillograph showing amplitude of noise included in a reproduction signal of the A/C head when a boundary magnetic shield sheet is removed from the combined TV/VCR of FIG. 1;

FIG. 5C is an oscillograph showing amplitude of noise included in a reproduction signal of the A/C head when a cap of the A/C head is removed from the combined TV/VCR of FIG. 1; and

FIG. 6 is a plan view showing an example of an audio magnetic shield sheet made of silicon steel to be provided on the cap of the A/C head.

In the drawings of the present application, the same or corresponding portions are denoted by the same reference numerals.

### DESCRIPTION OF THE PREFERRED EMBODIMENTS

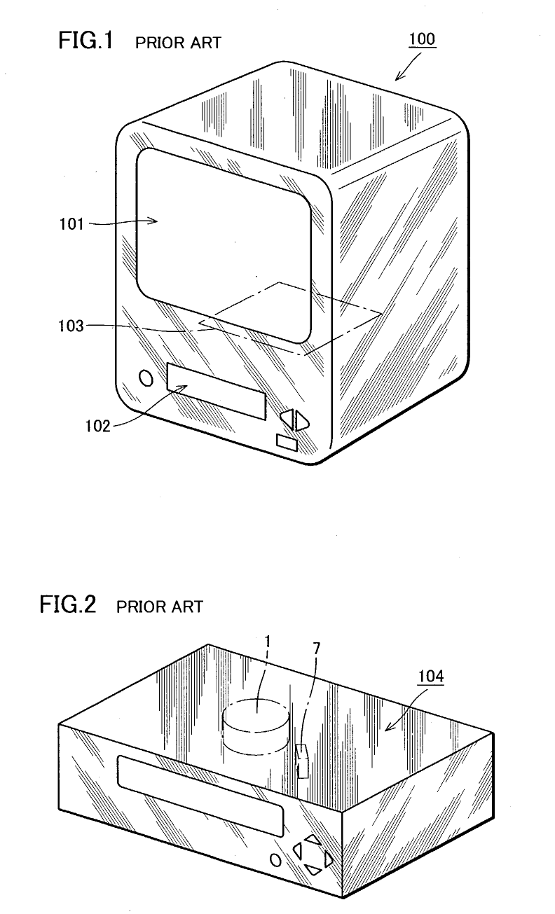

First, the present inventor investigated an adverse effect on video cassette recorder portion 102 caused by magnetic noise from television receiver portion 101 in combined TV/VCR 100 shown in FIG. 1.

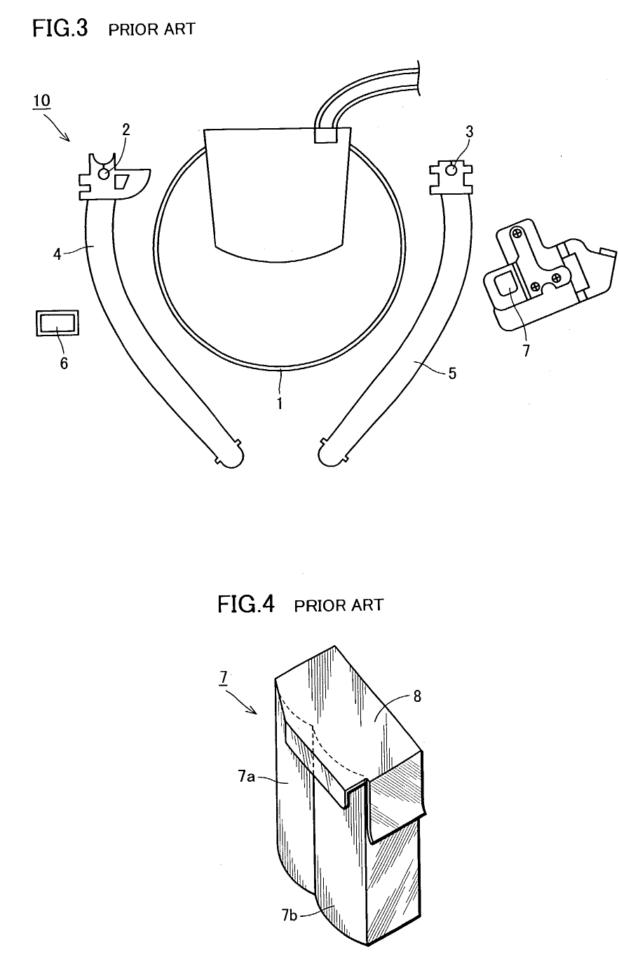

FIG. 3 shows a schematic plan view of a recording/reproducing portion 10 included in video cassette recorder portion 102. This recording/reproducing portion 10 includes a cylindrical magnetic head 1, tape loading posts 2, 3, guide grooves 4, 5, a magnetic erasing head 6 and an A/C head 7. FIG. 4 shows a schematic perspective view of A/C head 7 in more detail. It is noted that boundary magnetic shield sheet 103 shown in FIG. 1 is arranged above recording/reproducing portion 10 shown in FIG. 3.

Referring to FIG. 3, when a magnetic tape (not shown) is inserted into recording/reproducing portion 10, tape loading posts 2, 3 move to the illustrated positions along guide grooves 4, 5. Accordingly, the tape comes into contact with magnetic erasing head 6, and is turned back by loading post 2 to be in contact with an outer circumference of cylindrical magnetic head 1. The tape is then turned back by loading post 3 to be in contact with A/C head 7.

Magnetic erasing head 6 is used to erase magnetic signals over the entire width of the tape. Cylindrical magnetic head 1 is provided to record and reproduce an image signal at a central main portion in the width of the tape. A/C head 7 is provided to record and reproduce an audio signal and a control signal at both edges of the tape.

At A/C head 7 shown in FIG. 4, the magnetic tape travels from the upper left to the lower right in the perspective view. An audio erasing coil is wound at an upper end of a left portion 7a of A/C head 7, and is used to erase an audio signal recorded at an upper edge of the tape. An audio recording/reproducing coil is wound at an upper end of a right portion 7b of A/C head 7. The audio recording/reproducing coil is provided to record and reproduce an audio signal at an upper edge of the tape. A control signal recording/reproducing coil is wound at a lower end of right portion 7b of A/C head 7. The control signal recording/reproducing coil is provided to record and reproduce a control signal at a lower edge of the tape, for controlling movement of the tape etc.

An upper surface of A/C head 7 is covered with a cap 8 made of permalloy. As well known, permalloy has excellent magnetic permeability, allowing cap 8 to function as a magnetic shield. However, permalloy is an expensive material, so that the cost of cap 8 would be about two-third the cost of boundary magnetic shield 103 made of silicon steel, in spite of cap 8 being much smaller than boundary magnetic shield 103.

According to the present inventor's study, magnetic noise from a deflection coil arranged around a cathode-ray tube of television receiver portion 101 may have an adverse effect on recording/reproducing portion 10 in video cassette recorder portion 102. It is assumed that the deflection coil generates periodic magnetic noise of several tens Hz in connection with a raster on a display screen. Such noise with a relatively low frequency would be a problem in an audio signal, but would be no problem in a video signal with a high frequency.

Here, it is considered that A/C head 7 used for recording and reproducing an audio signal is double-protected against the magnetic noise from television receiver portion 101 by boundary magnetic shield 103 made of silicon steel and cap 8 made of permalloy. The present inventor, therefore, conducted various experiments as will be described below, based on the assumption that at least one of boundary magnetic shield 103 and cap 8, which are costly and troublesome in mounting, might be dispensed with.

First, noise included in an audio signal was measured, for the cases where both boundary magnetic shield 103 and cap 8 are provided (Experiment 1), where only cap 8 is provided without boundary magnetic shield 103 (Experiment 2), and where only boundary magnetic shield 103 is provided without cap 8 (Experiment 3). In each experiment, an audio signal reproduced by A/C head 7 from a tape with no sound recorded thereon was examined by an oscillograph while television receiver portion 101 was in an operating state.

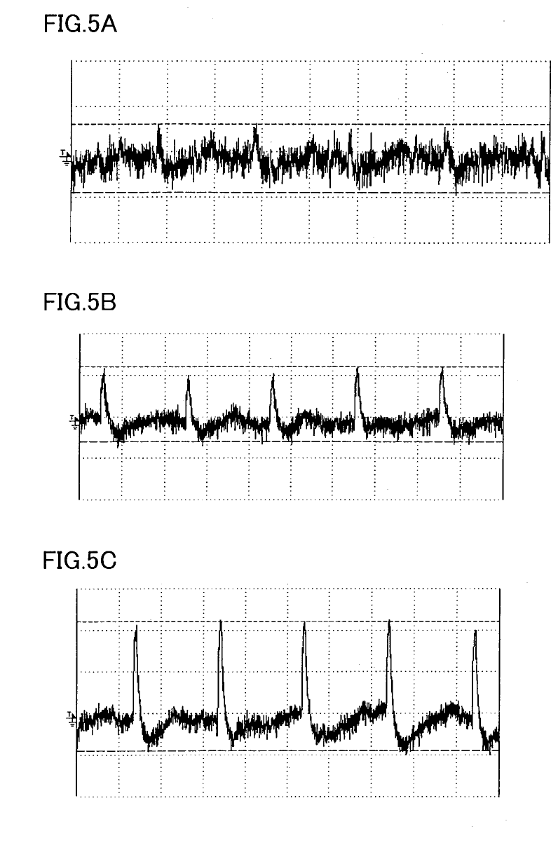

FIGS. 5A, 5B and 5C show oscillographs obtained in Experiments 1, 2 and 3, respectively. In each graph, one scale of the horizontal axis indicates time of 10 ms, while the vertical axis represents a noise signal by voltage. It should be noted, however, that one scale of the vertical axis indicates 20 mV in the graph of FIG. 5A, whereas one scale of the vertical axis indicates 50 mV in the graphs of FIGS. 5B and 5C.

As can be seen from FIG. 5A, in Experiment 1 where both boundary magnetic shield 103 and cap 8 were provided, the maximum noise amplitude was 30.0 mV. The level of the maximum noise amplitude of 30.0 mV is sufficiently small compared to a normal audio signal level, allowing a satisfactory commercial combined TV/VCR to be obtained. By contrast, as can be seen from FIG. 5B, in Experiment 2 where only cap 8 was provided without boundary magnetic shield 103, the maximum noise amplitude was 90.0 mV. It is clear that such a large noise amplitude level is not suitable to a commercial combined TV/VCR. Moreover, as can be seen from FIG. 5C, in Experiment 3 where only boundary magnetic shield 103 was provided without cap 8, the maximum noise amplitude was further increased to 155.5 mV.

The results of Experiments 1, 2 and 3 as above revealed that a commercially satisfactory combined TV/VCR cannot be provided if either one of boundary magnetic shield 103 and cap 8 is simply eliminated.

(Experiment 4)

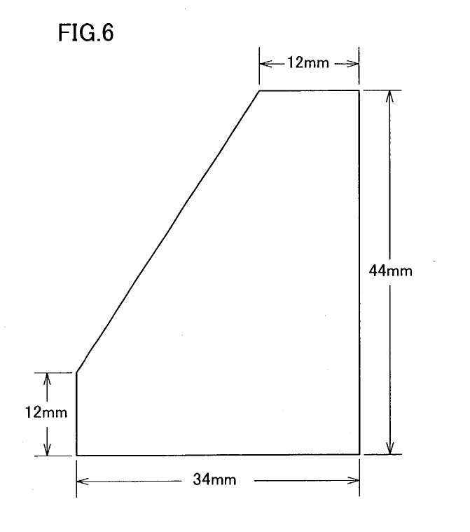

In the combined TV/VCR in Experiment 4, an audio magnetic shield sheet 9 made of silicon steel having the dimension and shape as shown in FIG. 6 was provided to be joined onto cap 8 made of permalloy, while boundary magnetic shield sheet 103 was dispensed with. Under such conditions, noise included in an audio signal was examined by an oscillograph similarly as in the cases of Experiments 1 to 3. Though the oscillograph is not presented here, as it is similar to the ones in FIGS. 5A to 5C, a maximum noise amplitude of 41.8 mV was obtained. This maximum noise level is a little higher than that in Experiment 1. It is, however, much lower than those in Experiments 2 and 3, and thus falls within a range sufficiently allowable for a commercial combined TV/VCR.

(Experiment 5)

In the combined TV/VCR in Experiment 5, silicon steel was used as a material for cap 8, in place of permalloy. Audio magnetic shield sheet 9 made of silicon steel shown in FIG. 6 was joined onto the cap made of silicon steel, while boundary magnetic shield sheet 103 was dispensed with. In Experiment 5 also, noise included in an audio signal was examined by an oscillograph. The result showed that the maximum noise amplitude was 42.4 mV. This maximum noise amplitude level is approximately the same as that in Experiment 4, and is within a range sufficiently allowable for a commercial combined TV/VCR.

(Experiment 6)

In the combined TV/VCR in Experiment 6, galvanized soft steel was used as a material for cap 8, in place of permalloy. Audio magnetic shield sheet 9 made of silicon steel shown in FIG. 6 was then joined onto the cap of soft steel, while boundary magnetic shield sheet 103 was dispensed with. In Experiment 6 also, noise included in an audio signal was examined by an oscillograph. The result showed that the maximum noise amplitude was 45. 2 mV. This maximum noise amplitude level is apparently higher than those in Experiments 4 and 5, but is still much lower than those in Experiments 2 and 3. Hence, the maximum noise amplitude level in Experiment 6 is considered to be close to the limit of the allowable range for a commercial combined TV/VCR.

Next, comparing with the conventional combined TV/VCR in Experiment 1, cost reduction in Experiments 4 to 6 will be considered.

In the combined TV/VCR of Experiment 4, though audio magnetic shield sheet 9 made of silicon steel is added, boundary magnetic shield sheet 103 made of silicon steel having a large area (100 cm²) is dispensed with. As can be seen from the measurements indicated in FIG. 6, audio magnetic shield sheet 9 has only a small area of about 9 cm² which is less than 0.09 times the area of boundary magnetic shield sheet 103. On the other hand, the area of audio magnetic shield sheet 9 is about eleven times larger as compared with the upper surface of the cap of A/C head 7 having an area of about 0.8 cm².

In the combined TV/VCR of Experiment 5, audio magnetic shield sheet 9 made of silicon steel is added while boundary magnetic shield sheet 103 made of silicon steel having a large area is dispensed with, and still further, cap 8 made of expensive permalloy is replaced by a cap made of inexpensive silicon steel. This silicon steel cap may be formed at half the cost of the permalloy cap or less. In the combined TV/VCR of Experiment 5, therefore, further cost reduction may be achieved compared to Experiment 4.

In the combined TV/VCR of Experiment 6, audio magnetic shield sheet 9 made of silicon steel is added while large-area boundary magnetic shield sheet 103 made of silicon steel is dispensed with, and still further, cap 8 made of expensive permalloy is replaced by a cap made of much less expensive soft steel. That is, the soft-steel cap is cheaper than the silicon steel cap, and can be formed at a cost close to one-fourth the cost of the permalloy cap. Therefore, the combined TV/VCR of Experiment 6 is considered to be allowable when a less expensive combined TV/VCR is desired, though the audio noise level thereof is close to the limit of a commercially allowable range.

Moreover, in the combined TV/VCR in each of Experiments 4 to 6above, large boundary magnetic shield sheet 103 which is hard to be handled is dispensed with and is replaced by small audio magnetic shield sheet 9 which is easy to be handled, facilitating assembly and thus improving the production efficiency.

The advantages in Experiments 4 to 6 as described above may also be applied to an independent video cassette recorder 104 as shown in FIG. 2, not limited to a combined TV/VCR.

A case for relatively inexpensive video cassette recorder 104 is generally formed by synthetic resin. In an independent video cassette recorder, a boundary magnetic shield sheet as in the combined TV/VCR is not provided. However, an independent television receiver is often put on the independent video cassette recorder. In such a case, similarly as in the above-described combined TV/VCR, magnetic noise from a deflection coil of the television receiver may have an adverse effect on the A/C head in the video cassette recorder.

It would be clear that the noise at the A/C head can significantly be reduced by providing an audio magnetic shield sheet of silicon steel on the cap of the A/C head in the video cassette recorder, similarly as in the above-described Experiments 4 to 6.

According to the present invention, therefore, a combined TV/VCR can be provided that eliminates the need for a large, hard-to-handle and costly boundary magnetic shield sheet. Furthermore, an independent video cassette recorder can be provided in which an audio signal is less affected even if an independent television receiver is mounted thereon.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A combined television receiver/video cassette recorder including an upper television receiver portion and a lower video cassette recorder portion, wherein
a boundary magnetic shield sheet of silicon steel conventionally used between said television receiver portion and said video cassette recorder portion is dispensed with, and
an audio magnetic shield sheet of silicon steel smaller than said boundary magnetic shield sheet is provided on a cap of an audio/control head included in said video cassette recorder portion.

2. The combined television receiver/video cassette recorder according to claim 1, wherein said audio magnetic shield sheet has an area of at least eleven times an area of said cap.

3. The combined television receiver/video cassette recorder according to claim 1, wherein said cap is formed of a silicon steel sheet.

4. A video cassette recorder, wherein
an audio magnetic shield sheet of silicon steel is provided on a cap of an audio/control head included in a recording/reproducing portion, in a case at least a top plate of which is made of synthetic resin.

5. The video cassette recorder according to claim 4, wherein said audio magnetic shield sheet has an area of at least eleven times an area of said cap.

6. The video cassette recorder according to claim 4, wherein said cap is formed of a silicon steel sheet.

7. An audio/control head to be used in a video cassette recorder portion in a combined television receiver/video cassette recorder including an upper television receiver portion and a lower video cassette recorder portion, without provision of a boundary magnetic shield sheet of silicon steel conventionally used between said television receiver portion and said video cassette recorder portion, wherein
said audio/control head has on its cap an audio magnetic shield sheet of silicon steel smaller than said boundary magnetic shield sheet.

8. The audio/control head according to claim 7, wherein said audio magnetic shield sheet has an area of at least eleven times an area of said cap.

9. The audio/control head according to claim 7, wherein said cap is formed of a silicon steel sheet.

10. An audio/control head to be used in a recording/reproducing portion of a video cassette recorder contained in a case at least a top plate of which is made of synthetic resin, wherein
said audio/control head has on its cap an audio magnetic shield sheet of silicon steel.

11. The audio/control head according to claim 10, wherein said audio magnetic shield sheet has an area of at least eleven times an area of said cap.

12. The audio/control head according to claim 10, wherein said cap is formed of a silicon steel sheet.
